(19) United States
(12) Patent Application Publication
(10) Pub. No.: US 2024/0116800 A1
(43) Pub. Date: Apr. 11, 2024

(54) GLASS PLATE, LAMINATED GLASS, WINDOW GLASS FOR VEHICLES, AND WINDOW GLASS FOR BUILDINGS

(71) Applicant: AGC Inc., Tokyo (JP)

(72) Inventors: Takato KAJIHARA, Tokyo (JP); Shigeki SAWAMURA, Tokyo (JP); Yutaka KUROIWA, Tokyo (JP)

(73) Assignee: AGC Inc., Tokyo (JP)

(21) Appl. No.: 18/543,883

(22) Filed: Dec. 18, 2023

Related U.S. Application Data
(63) Continuation of application No. PCT/JP2022/025478, filed on Jun. 27, 2022.

(30) Foreign Application Priority Data
Jun. 30, 2021 (JP) 2021-109448

(51) Int. Cl. C03C 3/087; B32B 17/10; C03C 3/091

(52) U.S. Cl. CPC C03C 3/087; B32B 17/10036; B32B 17/10119; B32B 17/10761; C03C 3/091; B60J 1/00

(57) ABSTRACT

A glass plate includes, in terms of molar percentage based on oxides: 70%≤SiO₂≤85%; 0.0%≤Al₂O₃≤10%; 0.0%≤B₂O₃≤15%; 1.5%≤MgO≤20%; 0.0%≤CaO≤20%; 0.0% 0 SrO≤5.0%; 0.0%≤BaO≤1.0%; 0.0% 0 ZnO≤5.0%; 1.0%≤Li₂O≤11%; 0.0%≤Na₂O≤10%; 0.0% K₂O≤10%; 3.0%≤R₂O 11%; 0.01% Fe₂O₃≤1.00%; and 2.0%≤RO≤20%, in which a temperature T₂ at which a glass viscosity is 10² dPa·s is 1,650° C. or lower, a temperature T12 at which a glass viscosity is 10¹² dPa·s is 730° C. or lower, a relative dielectric constant (Fr) at a frequency of 10 GHz is 6.5 or less, and a loss tangent (tan δ) at a frequency of 10 GHz is 0.0090 or less.

### CROSS-REFERENCE TO RELATED APPLICATIONS

This is a bypass continuation of International Patent Application No. PCT/JP2022/025478, filed on Jun. 27, 2022, which claims priority to Japanese Patent Application No. 2021-109448, filed on Jun. 30, 2021. The contents of these applications are hereby incorporated by reference in their entireties.

### TECHNICAL FIELD

The present invention relates to a glass plate, a laminated glass, a window glass for a vehicle, and a window glass for a building.

### BACKGROUND ART

In recent years, construction of communication infrastructure by a fourth generation mobile communication system (4G) Long Term Evolution (LTE) and a fifth generation mobile communication system (5G) has progressed, and further, spread of high-speed and large-capacity data communication such as communication by a millimeter wave radar of 30 GHz or more including autonomous driving has been expected in the future.

However, in the case where such a millimeter wave radar is installed in a vehicle or a building and a millimeter radio wave is transmitted through a window glass, a window glass for a vehicle and a window glass for a building in the related art have low millimeter radio wave transmissivity, and thus are not suitable as a next generation glass. This is due to poor dielectric properties of a soda lime glass which is currently used in many window glasses for a vehicle and window glasses for a building.

On the other hand, examples of a glass having high millimeter radio wave transmissivity include a glass composition such as an alkali-free glass or a low-alkali glass. For example, Patent Literature 1 discloses a window member having excellent radio wave transmissivity, which uses an alkali-free glass as a radio wave transmitting member.
Patent Literature 1: WO2020/090717

### SUMMARY OF INVENTION

However, in a glass composition such as alkali-free glass or low-alkali glass, raw materials are difficult to melt, and therefore, glass melting at a higher temperature is required. In addition, in the case where a glass plate requiring a bending step is manufactured, such as a window glass for a vehicle having a three-dimensional curved surface shape such as a windshield or a window glass for a building having a curved surface shape with a design, forming at a high temperature is required as compared with a soda lime glass.

In view of the above problems, the present invention provides a glass plate having a high millimeter wave transmissivity, a low melting temperature, a low bending forming temperature, and excellent processability, and a laminated glass, a window glass for a vehicle, and a window glass for a building including the glass plate.

### Solution to Problem

A glass plate according to an embodiment of the present invention includes, in terms of molar percentage based on oxides:
70%≤SiO₂≤85%;
0.0%≤Al₂O₃≤10%;
0.0%≤B₂O₃≤15%;
1.5%≤MgO≤20%;
0.0%≤CaO≤20%;
0.0%≤SrO≤5.0%;
0.0%≤BaO≤1.0%;
0.0%≤ZnO≤5.0%;
1.0%≤Li₂O≤11%;
0.0%≤Na₂O≤10%;
0.0%≤K₂0≤10%;
3.0%≤R₂0≤11%;
0.01%≤Fe₂O₃≤1.00%; and
2.0%≤RO≤20%,
in which R₂O represents a total amount of Li₂O, Na₂O, and K₂O, and RO represents a total amount of MgO, CaO, SrO, and BaO,
a temperature T₂ at which a glass viscosity is 10² dPa·s is 1,650° C. or lower,
a temperature T₁₂ at which a glass viscosity is 10¹² dPa·s is 730° C. or lower,
a relative dielectric constant (∈ᵣ) at a frequency of 10 GHz is 6.5 or less, and
a loss tangent (tan δ) at a frequency of 10 GHz is 0.0090 or less.

In a glass plate according to one aspect of the present disclosure, an average thermal expansion coefficient at 50° C. to 350° C. may be 40×10⁻⁷/K or more.

In a glass plate according to one aspect of the present invention, Al₂O₃-B₂O₃>0.0% may be satisfied in terms of molar percentage based on oxides.

A glass plate according to one aspect of the present invention may be substantially free of B₂O₃.

In a glass plate according to one aspect of the present invention, 5.0%≤B₂O₃≤15% may be satisfied in terms of molar percentage based on oxides.

In a glass plate according to one aspect of the present invention, 0.0%≤B₂O₃≤5.0% may be satisfied in terms of molar percentage based on oxides.

In a glass plate according to one aspect of the present invention, when a thickness thereof is converted into 2.00 mm, a visible light transmittance Tv defined by ISO-9050:2003 using a D65 light source may be 75% or more.

In a glass plate according to one aspect of the present invention, when a thickness thereof is converted into 2.00 mm, a total solar transmittance Tts defined by ISO-13837:2008 convention A and measured at a wind speed of 4 m/s may be 88% or less.

In a glass plate according to one aspect of the present invention, the temperature T₁₂ may be 650° C. or lower.

In a glass plate according to one aspect of the present invention, the relative dielectric constant (εᵣ) at the frequency of 10 GHz may be 6.0 or less.

In a glass plate according to one aspect of the present invention, 3.0%≤Li₂0≤10% may be satisfied in terms of molar percentage based on oxides.

In a glass plate according to one aspect of the present invention, 1.8%≤MgO≤8.0% may be satisfied in terms of molar percentage based on oxides.

In a glass plate according to one aspect of the present invention, 71%≤SiO₂≤85% may be satisfied in terms of molar percentage based on oxides.

In a glass plate according to one aspect of the present invention, 0.05% Fe₂O₃≤1.00% may be satisfied in terms of molar percentage based on oxides.

A laminated glass according to an embodiment of the present invention including: a first glass plate; a second glass plate; and an interlayer sandwiched between the first glass plate and the second glass plate, in which at least one of the first glass plate and the second glass plate is the above glass plate.

In a laminated glass according to one aspect of the present invention, a total thickness of the first glass plate, the second glass plate, and the interlayer may be 6.00 mm or less, and a visible light transmittance Tv defined by ISO-9050:2003 using a D65 light source may be 70% or more.

In a laminated glass according to one aspect of the present invention, a total thickness of the first glass plate, the second glass plate, and the interlayer may be 6.00 mm or less, and a total solar transmittance Tts defined by ISO-13837:2008 convention A and measured at a wind speed of 4 m/s may be 80% or less.

In a laminated glass according to one aspect of the present invention, a total thickness of the first glass plate, the second glass plate, and the interlayer may be 6.00 mm or less, and a maximum value of a radio wave transmission loss S21 may be −4.0 dB or more when a TM radio wave having a frequency of 75 GHz to 80 GHz is incident on the first glass plate at an incident angle of 60°.

In a laminated glass according to one aspect of the present invention, a total thickness of the first glass plate, the second glass plate, and the interlayer may be 6.00 mm or less, and a maximum value of a radio wave transmission loss S21 may be −4.0 dB or more when a TM radio wave having a frequency of 75 GHz to 80 GHz is incident on the first glass plate at an incident angle of 45°.

In a laminated glass according to one aspect of the present invention, a total thickness of the first glass plate, the second glass plate, and the interlayer may be 6.00 mm or less, and a maximum value of a radio wave transmission loss S21 may be −4.0 dB or more when a TM radio wave having a frequency of 75 GHz to 80 GHz is incident on the first glass plate at an incident angle of 20°.

A window glass for a vehicle according to an embodiment of the present invention includes the above glass plate.

A window glass for a building according to an embodiment of the present invention includes the above glass plate.

A window glass for a vehicle according to another embodiment of the present invention includes the above laminated glass.

According to the present invention, it is possible to provide a glass plate having a high millimeter wave transmissivity, a low melting temperature, a low bending forming temperature, and excellent processability, and a laminated glass, a window glass for a vehicle, and a window glass for a building including the glass plate.

### BRIEF DESCRIPTION OF DRAWINGS

FIG. 1 is a cross-sectional view of an example of a laminated glass according to an embodiment of the present invention.

FIG. 2 is a conceptual view illustrating a state in which a laminated glass according to an embodiment of the present invention is used as a window glass for a vehicle.

FIG. 3 is an enlarged view of a portion S illustrated in FIG. 2.

FIG. 4 is a cross-sectional view taken along a line Y-Y in FIG. 3.

### DESCRIPTION OF EMBODIMENTS

Hereinafter, embodiments of the present invention will be described in detail. In the following drawings, members and portions having the same functions may be denoted by the same reference numerals, and duplicate descriptions may be omitted or simplified. The embodiments described in the drawings are schematically for the purpose of clearly explaining the present invention, and do not necessarily accurately represent a size or a scale of an actual product.

In the present description, unless otherwise specified, an evaluation such as “high/low millimeter radio wave transmissivity” means an evaluation for radio wave (including quasi-millimeter wave and millimeter wave) transmissivity, and means, for example, radio wave transmissivity of a glass with respect to a radio wave having a frequency of 10 GHz to 90 GHz.

In the present description, the expression that a glass “is substantially free of” a component means that the component is not contained except for inevitable impurities, and means that the component is not positively added. Specifically, the expression means that a content of each component in the glass is about 100 ppm or less.

[Glass Plate]

A glass plate according to an embodiment of the present invention includes, in terms of molar percentage based on oxides:
70%≤SiO₂ 85%;
0.0%≤Al₂O₃≤10%;
0.0%≤B₂03≤15%;
1.5%≤MgO≤20%;
0.0%≤CaO≤20%;
0.0%≤SrO≤5.0%;
0.0%≤BaO≤1.0%;
0.0%≤ZnO≤5.0%;
1.0% Li₂0≤11%;
0.0%≤Na₂O≤10%;
0.0%≤K₂0≤10%;
3.0%≤R₂0≤11%;
0.01%≤Fe₂O₃≤1.00%; and
2.0%≤RO≤20%,
in which R₂O represents a total amount of Li₂O, Na₂O, and K₂O, and RO represents a total amount of MgO, CaO, SrO, and BaO,
a temperature T₂ at which a glass viscosity is 10² dPa·s is 1,650° C. or lower,
a temperature T₁₂ at which a glass viscosity is 10¹² dPa·s is 730° C. or lower,
a relative dielectric constant (Fr) at a frequency of 10 GHz is 6.5 or less, and
a loss tangent (tan δ) at a frequency of 10 GHz is 0.0090 or less.

Hereinafter, a composition range of each component contained in the glass plate according to the present embodiment will be described. The composition range of each component is expressed in terms of molar percentage based on oxides unless otherwise specified.

SiO₂ is an essential component of the glass plate according to the present embodiment. A content of SiO₂ is 70% or more and 85% or less. SiO₂ contributes to an increase in Young's modulus, thereby making it easier to ensure a strength required for vehicle applications, building applications, and the like. In the case where the content of SiO₂ is small, it is difficult to ensure weather resistance, and an average thermal expansion coefficient becomes too large, which may cause thermal cracking of the glass plate. On the other hand, in the case where the content of SiO₂ is too large, a viscosity at the time of melting the glass increases, which may make it difficult to produce the glass.

The content of SiO₂ in the glass plate according to the present embodiment is preferably 71% or more, more preferably 72% or more, and still more preferably 730% or more. In addition, the content of SiO₂ in the glass plate according to the present embodiment is preferably 82% or less, more preferably 80% or less, still more preferably 78% or less, and particularly preferably 76% or less.

Al₂O₃ is an optional component of the glass plate according to the present embodiment. A content of Al₂O₃ is 0.0% or more and 10% or less. By containing Al₂O₃, the weather resistance can be ensured, and thermal cracking of the glass plate due to an increase in the average thermal expansion coefficient can be prevented. On the other hand, in the case where the content of Al₂O₃ is too large, the viscosity at the time of melting the glass increases, which may make it difficult to bend the glass.

In the case where Al₂O₃ is contained, the content of Al₂O₃ is preferably 0.50% or more, more preferably 1.0% or more, and still more preferably 1.5% or more in order to prevent phase separation of the glass and improve the weather resistance. The content of Al₂O₃ is preferably 9.0% or less, more preferably 8.0% or less, still more preferably 7.0% or less, particularly preferably 6.0% or less, and most preferably 5.0% or less from viewpoints of maintaining T₁₂ at a low level and making it easy to produce the glass, and from a viewpoint of increasing the millimeter radio wave transmissivity.

B₂O₃ is an optional component of the glass plate according to the present embodiment. A content of B₂O₃ is 0.0% or more and 15% or less. B₂O₃ is contained in order to increase the glass strength and the millimeter radio wave transmissivity, and also contributes to improvement of a melting property.

The content of B₂O₃ in the glass plate according to the present embodiment is preferably 1.0% or more, more preferably 1.5% or more, and still more preferably 2.0% or more.

In addition, in the case where the content of B₂O₃ is too large, an alkali element is likely to volatilize during melting and forming, which may lead to a decrease in glass quality and a decrease in acid resistance and alkali resistance. Therefore, the content of B₂O₃ is preferably 14% or less, more preferably 13% or less, even more preferably 12% or less, still more preferably 11% or less, particularly preferably 10% or less, and most preferably 9% or less.

More specifically, the glass plate according to the present embodiment is classified into the following three aspects in accordance with the content of B₂O₃. That is, a first aspect and a second aspect of the glass plate according to the present embodiment are aspects that are substantially free of B₂O₃ or contain a small amount of B₂O₃, and are characterized in that the relative dielectric constant, the loss tangent, and T₁₂ can be reduced while suppressing volatilization at the time of melting the glass. In addition, a third aspect of the glass plate according to the present embodiment is an aspect containing a relatively large amount of B₂O₃, and is characterized in that the relative dielectric constant, the loss tangent, and T₁₂ can be further reduced, although there is a concern that the glass plate may volatilize at the time of melting the glass.

The first aspect of the glass plate according to the present embodiment is substantially free of B₂O₃. Accordingly, it is possible to suppress volatilization of an alkali component at the time of melting the glass.

In addition, in the second aspect of the glass plate according to the present embodiment, the content of B₂O₃ is 0.0% or more and less than 5.0%. Accordingly, it is possible to reduce the relative dielectric constant, the loss tangent, and T₁₂ while suppressing volatilization at the time of melting the glass. In the glass plate according to the present aspect, the content of B₂O₃ is preferably 1.0% or more, more preferably 1.5% or more, and still more preferably 2.0% or more. In addition, the content of B₂O₃ is preferably 4.5% or less, more preferably 4.0% or less, and still more preferably 3.5% or less.

In the third aspect of the glass plate according to the present embodiment, the content of B₂O₃ is 5.0% or more and 15% or less. Accordingly, it is possible to further reduce the relative dielectric constant, the loss tangent, and T₁₂. In the glass plate according to the present aspect, the content of B₂O₃ is preferably 8% or more, more preferably 10% or more, and still more preferably 12% or more. In addition, the content of B₂O₃ is preferably 14.5% or less, more preferably 14.3% or less, and still more preferably 14.0% or less.

In the first aspect and the second aspect of the glass plate according to the present embodiment, a value (Al₂O₃-B₂O₃) obtained by subtracting the content of B₂O₃ from the content of Al₂O₃ is preferably larger than 0.0%. That is, satisfying Al₂O₃-B₂O₃>0.0% is preferable. Accordingly, it is possible to suppress phase separation at the time of producing the glass plate. Al₂O₃-B₂O₃ is preferably 0.10% or more, more preferably 0.50% or more, and still more preferably 1.0% or more.

In order to increase the millimeter radio wave transmissivity, SiO₂+Al₂O₃+B₂O₃ in the glass plate according to the present embodiment, that is, a total of the content of SiO₂, the content of Al₂O₃, and the content of B₂O₃ is preferably 70% or more and 95% or less.

Further, in consideration of maintaining the temperature T₂ of the glass plate according to the present embodiment at a low level and making it easy to produce the glass, SiO₂+Al₂O₃+B₂O₃ is more preferably 92% or less, still more preferably 90% or less, particularly preferably 85% or less, and most preferably 80% or less.

However, in the case where the content of SiO₂+Al₂O₃+B₂O₃ is too small, the weather resistance may be deteriorated, and a relative dielectric constant (εᵣ) and a loss tangent (tan δ) may become too large. Therefore, SiO₂+Al₂O₃+B₂O₃ in the glass plate according to the present embodiment is more preferably 75% or more, and still more preferably 77% or more.

MgO is an essential component of the glass plate according to the present embodiment. Since the glass plate according to the present embodiment contains MgO as an essential component in a predetermined amount, the viscosity of the glass is reduced, and therefore, the temperature T₂ at which the glass viscosity is 10² dPa·s can be lowered, which greatly contributes to the improvement of the melting property of the glass. In addition, MgO is preferable because it can suppress an increase in relative dielectric constant as compared with CaO.

A content of MgO is 1.5% or more and 20% or less. MgO is a component that promotes melting of a glass raw material as described above and improves the weather resistance and the Young's modulus. The content of MgO is preferably 1.8% or more, more preferably 2.0% or more, even more preferably 2.5% or more, still more preferably 3.0% or more, particularly preferably 3.5% or more, and most preferably 4.0% or more.

In addition, in the case where the content of MgO is 20% or less, it is possible to suppress an increase in the relative dielectric constant (εᵣ) and the loss tangent (tan δ) while controlling T₂ and T₁₂ in appropriate ranges. The content of MgO is preferably 15% or less, more preferably 10% or less, still more preferably 9.0% or less, particularly preferably 8.0% or less, and most preferably 7.5% or less.

CaO is an optional component of the glass plate according to the present embodiment, and may be contained in a certain amount for improving the melting property of the glass raw material. A content of CaO is 0.0% or more and 20% or less. In the case where CaO is contained, the content thereof is preferably 2.0% or more, more preferably 2.5% or more, still more preferably 3.0% or more, particularly preferably 3.5% or more, and most preferably 4.0% or more. Accordingly, the melting property and the formability (decrease in T₂ and decrease in T₁₂) of the glass raw material are improved.

In addition, by setting the content of CaO to 20% or less, an increase in a density of the glass is prevented, and a low brittleness and the strength are maintained. In order to prevent the degradation of brittleness and to prevent the increase in the relative dielectric constant (εᵣ) and the loss tangent (tan δ) of the glass, the content of CaO is preferably 18% or less, more preferably 16% or less, still more preferably 14% or less, particularly preferably 12% or less, and most preferably 10% or less.

SrO is an optional component of the glass plate according to the present embodiment, and may be contained in a certain amount for improving the melting property of the glass raw material. A content of SrO is 0.0% or more and 5.0% or less. In the case where SrO is contained, the content thereof is preferably 0.10% or more, more preferably 0.20% or more, still more preferably 0.30% or more, particularly preferably 0.40% or more, and most preferably 0.50% or more. Accordingly, the melting property and the formability (decrease in T₂ and decrease in T₁₂) of the glass raw material are improved.

In addition, by setting the content of SrO to 5.0% or less, the increase in the density of the glass is prevented, and the low brittleness and the strength are maintained. In order to prevent the degradation of brittleness and to prevent the increase in the relative dielectric constant (εᵣ) and the loss tangent (tan δ) of the glass, the content of SrO is preferably 5.0% or less. In addition, the content of SrO is more preferably 4.0% or less, still more preferably 3.0% or less, particularly preferably 2.0% or less, and most preferably 1.0% or less.

BaO is an optional component of the glass plate according to the present embodiment, and may be contained in a certain amount for improving the melting property of the glass raw material. A content of BaO is 0.0% or more and 1.0% or less. In the case where BaO is contained, the content thereof is preferably 0.1% or more, more preferably 0.2% or more, and most preferably 0.3% or more. Accordingly, the melting property and the formability (decrease in T₂ and decrease in T₁₂) of the glass raw material are improved.

In addition, by setting the content of BaO to 1.0% or less, the increase in the density of the glass is prevented, and the low brittleness and the strength are maintained. In order to prevent the degradation of brittleness and to prevent the increase in the relative dielectric constant (εᵣ) and the loss tangent (tan δ) of the glass, the content of BaO is preferably 0.9% or less. In addition, the content of BaO is more preferably 0.8% or less, still more preferably 0.6% or less, and particularly preferably 0.5% or less, and it is most preferable that the glass plate be substantially free of BaO.

ZnO is an optional component of the glass plate according to the present embodiment, and may be contained in a certain amount for decreasing the viscosity of the glass. A content of ZnO is 0.0% or more and 5.0% or less. In the case where ZnO is contained, the content thereof is preferably 0.10% or more, more preferably 0.50% or more, and still more preferably 1.0% or more.

In addition, by setting the content of ZnO to 5.0% or less, the increase in the relative dielectric constant (εᵣ) and the loss tangent (tan δ) can be prevented. In order to prevent the increase in the relative dielectric constant (εᵣ) and the loss tangent (tan δ), the content of ZnO is preferably 3.0% or less. In addition, the content of ZnO is more preferably 2.5% or less, and still more preferably 2.0% or less.

Li₂O is an essential component of the glass plate according to the present embodiment. Since the glass plate according to the present embodiment contains Li₂O as an essential component in a predetermined amount, the viscosity of the glass is reduced, and therefore, the temperature T₂ at which the glass viscosity is 10² dPa·s can be lowered, which greatly contributes to the improvement of the melting property of the glass.

A content of Li₂O is 1.0% or more and 11% or less. Li₂O is a component that improves the melting property of the glass as described above, and is a component that increases the Young's modulus and also contributes to the increase in the glass strength. Therefore, by containing Li₂O, the formability of the window glass for a vehicle and the window glass for a building is improved.

The content of Li₂O is preferably 2.0% or more, more preferably 2.5% or more, still more preferably 3.0% or more, particularly preferably 3.5% or more, and most preferably 4.0% or more.

On the other hand, in the case where the content of Li₂O is too large, devitrification or the phase separation may occur at the time of producing the glass, which may make the production difficult. In addition, a large content of Li₂O may cause an increase in raw material cost and an increase in the relative dielectric constant (εᵣ) and the loss tangent (tan δ). Therefore, the content of Li₂O is preferably 10% or less, more preferably 9.0% or less, still more preferably 8.0% or less, particularly preferably 7.5% or less, and most preferably 7.0% or less.

Na₂O is an optional component of the glass plate according to the present embodiment. A content of Na₂O is 0.0% or more and 10% or less. By containing Na₂O, the glass viscosity is decreased, and thus the formability of the window glass for a vehicle or the window glass for a building is improved. In the case where Na₂O is contained, the content thereof is preferably 0.10% or more, more preferably 0.20% or more, still more preferably 0.30% or more, particularly preferably 0.40% or more, and most preferably 0.50% or more.

On the other hand, an excessively large content of Na₂O causes the increase in the relative dielectric constant (Fr) and the loss tangent (tan δ). Therefore, the content of Na₂O is preferably 9.0% or less, more preferably 7.0% or less, still more preferably 5.0% or less, particularly preferably 4.0% or less, and most preferably 3.0% or less.

K₂O is an optional component of the glass plate according to the present embodiment. A content of K₂O is 0.0% or more and 10% or less. By containing K₂O, the glass viscosity is decreased, and thus the formability of the window glass for a vehicle or the window glass for a building is improved. In the case where K₂O is contained, the content thereof is preferably 0.10% or more, more preferably 0.20% or more, still more preferably 0.30% or more, particularly preferably 0.40% or more, and most preferably 0.50% or more.

On the other hand, an excessively large content of K₂O causes the increase in the relative dielectric constant (εᵣ) and the loss tangent (tan δ). Therefore, the content of K₂O is preferably 9.0% or less, more preferably 7.0% or less, still more preferably 5.0% or less, particularly preferably 4.0% or less, and most preferably 3.0% or less.

R₂O means a total content of Li₂O, Na₂O, and K₂O. A content of R₂O is 3.0% or more and 11% or less. In the case where R₂O in the glass plate according to the present embodiment is 11% or less, the formability of the window glass for a vehicle or the window glass for a building is improved while maintaining the weather resistance and the millimeter radio wave transmissivity. R₂O in the glass plate according to the present embodiment is preferably 10.5% or less, more preferably 10.0% or less, still more preferably 9.5% or less, particularly preferably 9.0% or less, and most preferably 8.5% or less.

In addition, from the viewpoint of lowering the temperatures T₂ and T₁₂ at the time of production, or in order to facilitate heating by direct energization to a glass melting solution, R₂O in the glass plate according to the present embodiment is preferably 3.5% or more, more preferably 4.0% or more, still more preferably 4.5% or more, particularly preferably 5.0% or more, and most preferably 5.5% or more.

Fe₂O₃ is an essential component of the glass plate according to the present embodiment, and is contained for providing a heat insulation property. A content of Fe₂O₃ is 0.01% or more and 1.00% or less. The content of Fe₂O₃ herein refers to a total amount of iron including FeO which is an oxide of divalent iron and Fe₂O₃ which is an oxide of trivalent iron.

In the case where the content of Fe₂O₃ is less than 0.01%, the glass plate may not be able to be used for applications requiring a heat insulation property, and it may be necessary to use an expensive raw material having a low iron content for production of the glass plate. Further, in the case where the content of Fe₂O₃ is less than 0.01%, heat radiation may reach a bottom surface of a melting furnace more than necessary at the time of melting the glass, and a load may be applied to the melting furnace. The content of Fe₂O₃ in the glass plate according to the present embodiment is preferably 0.05% or more, more preferably 0.10% or more, still more preferably 0.15% or more, and particularly preferably 0.17% or more.

On the other hand, in the case where the content of Fe₂O₃ is too large, heat transfer by radiation may be hindered and the raw material may be difficult to melt during the production. Further, in the case where the content of Fe₂O₃ is too large, a visible light transmittance is decreased, which may make the glass plate unsuitable for the window glass for a vehicle and the like. The content of Fe₂O₃ is preferably 0.80% or less, more preferably 0.50% or less, still more preferably 0.40% or less, and particularly preferably 0.25% or less.

In addition, iron ions contained in the above Fe₂O₃ preferably satisfy 0.20≤[Fe²⁺]/([Fe²⁺]+[Fe³⁺])≤0.70 on a mass basis. Accordingly, a visible light transmittance and a near-infrared light transmittance suitable for the window glass for a vehicle or the window glass for a building can be implemented.

Here, the terms “[Fe²⁺]” and “[Fe³⁺]” respectively mean contents of Fe²⁺ and Fe³⁺ contained in the glass plate according to the present embodiment. In addition, the term “[Fe₂+]/([Fe₂+]+[Fe³⁺])” means a ratio of the content of Fe²⁺ to a total content of Fe²⁺ and Fe³⁺ in the glass plate according to the present embodiment.

[Fe²⁺]/([Fe²⁺]+[Fe³⁺]) is determined by the following method.

After decomposing a crushed glass with a mixed acid of hydrofluoric acid and hydrochloric acid at room temperature, a certain amount of a degradation solution is dispensed into a plastic container, and a hydroxylammonium chloride solution is added to reduce Fe³⁺ in a sample solution to Fe²⁺. Thereafter, a 2,2′-dipyridyl solution and an ammonium acetate buffer solution are added to develop a color of Fe²⁺. A color development solution is adjusted to a constant amount with ion-exchanged water, and an absorbance at a wavelength of 522 nm is measured with an absorptiometer. Then, a concentration is calculated based on a calibration curve prepared by using a standard solution to determine an amount of Fe²⁺. Since Fe³⁺ in the sample solution is reduced to Fe²⁺, the amount of Fe²⁺ means “[Fe²⁺]+[Fe³⁺]” in the sample.

Next, after decomposing the crushed glass with the mixed acid of hydrofluoric acid and hydrochloric acid at room temperature, a certain amount of the degradation solution is dispensed into a plastic container, and a 2,2′-dipyridyl solution and an ammonium acetate buffer solution are quickly added to develop a color of Fe²⁺ alone. A color development solution is adjusted to a constant amount with ion-exchanged water, and an absorbance at a wavelength of 522 nm is measured with an absorptiometer. Then, a concentration is calculated based on the calibration curve prepared by using the standard solution to calculate the amount of Fe²⁺. The amount of Fe²⁺ means [Fe²⁺] in the sample.

Then, [Fe²⁺]/([Fe²⁺]+[Fe³⁺]) is calculated based on the determined [Fe²⁺] and [Fe²⁺]+[Fe³⁺].

RO represents a total content of MgO, CaO, SrO, and BaO. A content of RO is 2.0% or more and 20% or less. In the case where the content of RO in the glass plate according to the present embodiment is 20% or less, the increase in the relative dielectric constant (εᵣ) and the loss tangent (tan δ) can be prevented while maintaining the weather resistance. The content of RO in the glass plate according to the present embodiment is preferably 19% or less, more preferably 18% or less, still more preferably 17% or less, even still more preferably 16% or less, particularly preferably 15% or less, and most preferably 14% or less.

In addition, from the viewpoint of lowering the temperatures T₂ and T₁₂ during the production, or from a viewpoint of improving the formability of the window glass for a vehicle or the window glass for a building, the content of RO in the glass plate according to the present embodiment is preferably 4.0% or more, more preferably 6.0% or more, particularly preferably 8.0% or more, and most preferably 10% or more.

In the glass plate according to the present embodiment, the temperature T₂ at which the glass viscosity is 10² dPa·s is 1,650° C. or lower. In the case where T₂ is 1,650° C. or less, the glass raw material has excellent melting property. Examples of a method for setting T₂ to 1,650° C. or lower include a method of adjusting the content of MgO or Li₂O to a predetermined range as described above. In the glass plate according to the present embodiment, T₂ is preferably 1,640° C. or lower, more preferably 1,630° C. or lower, still more preferably 1,620° C. or lower, particularly preferably 1,615° C. or lower, and most preferably 1,610° C. or lower.

A lower limit of T₂ is not particularly limited, and in order to maintain the weather resistance and the density of the glass, T₂ is typically preferably 1,400° C. or higher, more preferably 1,450° C. or higher, and still more preferably 1,500° C. or higher.

In the glass plate according to the present embodiment, the temperature T₁₂ at which the glass viscosity is 10¹² dPa·s is 730° C. or lower. In the case where T₁₂ is 730° C. or lower, it is possible to perform the bending forming at a low temperature. Examples of a method for setting T₁₂ to 730° C. or lower include a method of adjusting the contents of CaO, MgO, Li₂O, and the like to a predetermined range. In the glass plate according to the present embodiment, T₁₂ is preferably 720° C. or lower, more preferably 700° C. or lower, further preferably 680° C. or lower, still more preferably 670° C. or lower, even still more preferably 650° C. or lower, and yet still more preferably 630° C. or lower.

In addition, from a viewpoint of a firing temperature of a black ceramic, which is an example of a light insulation layer to be printed on a windshield, T₁₂ is preferably 550° C. or higher, more preferably 560° C. or higher, still more preferably 570° C. or higher, and particularly preferably 590° C. or higher.

In addition, in the glass plate according to the present embodiment, a low loss tangent (tan δ) can be obtained by adjusting compositions, and as a result, a dielectric loss can be reduced, and a high millimeter radio wave transmissivity can be implemented. In the glass plate according to the present embodiment, the relative dielectric constant (εᵣ) can also be adjusted by adjusting the compositions in the same manner, reflection of a radio wave at an interface with an interlayer can be prevented, and a high millimeter radio wave transmissivity can be implemented.

The relative dielectric constant (εᵣ) of the glass plate according to the present embodiment at a frequency of 10 GHz is preferably 6.5 or less. In the case where the relative dielectric constant (εᵣ) at the frequency of 10 GHz is 6.5 or less, a difference in the relative dielectric constant (εᵣ) from the interlayer is small, and the reflection of the radio wave at the interface with the interlayer can be prevented. The relative dielectric constant (εᵣ) of the glass plate according to the present embodiment at the frequency of 10 GHz is preferably 6.4 or less, more preferably 6.3 or less, still more preferably 6.2 or less, particularly preferably 6.1 or less, and most preferably 6.0 or less. In addition, a lower limit of the relative dielectric constant (εᵣ) of the glass plate according to the present embodiment at the frequency of 10 GHz is not particularly limited, and is, for example, 4.5 or more.

In addition, the loss tangent (tan δ) of the glass plate according to the present embodiment at the frequency of 10 GHz is 0.0090 or less. In the case where the loss tangent (tan δ) at the frequency of 10 GHz is 0.0090 or less, the radio wave transmissivity can be increased. The loss tangent (tan δ) of the glass plate according to the present embodiment at the frequency of 10 GHz is preferably 0.0089 or less, more preferably 0.0088 or less, still more preferably 0.0087 or less, particularly preferably 0.0086 or less, and most preferably 0.0085 or less. In addition, a lower limit of the loss tangent (tan δ) of the glass plate according to the present embodiment at the frequency of 10 GHz is not particularly limited, and is, for example, 0.0050 or more.

In the case where the relative dielectric constant (εᵣ) and the loss tangent (tan δ) of the glass plate according to the present embodiment at the frequency of 10 GHz satisfy the above ranges, a high millimeter radio wave transmissivity can be implemented even at a frequency of 10 GHz to 90 GHz.

The relative dielectric constant (εᵣ) and the loss tangent (tan δ) of the glass plate according to the present embodiment at the frequency of 10 GHz can be measured with, for example, a split post dielectric resonator method (SPDR method). For such a measurement, a nominal fundamental frequency of 10 GHz type split post dielectric resonator manufactured by QWED Company, a vector network analyzer E8361C manufactured by Keysight Technologies, 85071E option 300 dielectric constant calculation software manufactured by Keysight Technologies, or the like may be used.

The average thermal expansion coefficient of the glass plate according to the present embodiment at 50° C. to 350° C. is preferably 40×10⁻⁷/K or more. In the case where the average thermal expansion coefficient of the glass plate according to the present embodiment is 40×10⁻⁷/K or more, the bending processability at a low temperature is good. This can be implemented by setting the content of R₂0 to 3.0% or more and the content of RO to 2.0% or more.

The average thermal expansion coefficient of the glass plate according to the present embodiment at 50° C. to 350° C. is preferably 45×10⁻⁷/K or more, more preferably 50×10⁻⁷/K or more, and particularly preferably 55×10⁻⁷/K or more. On the other hand, in the glass plate according to the present embodiment, in the case where the average thermal expansion coefficient is too large, thermal stress due to temperature distribution of the glass plate may be likely to occur in a forming step or a slow cooling step of the glass plate, or a forming step of the window glass for a vehicle or the window glass for a building, and the thermal cracking of the glass plate may occur.

In addition, in the glass plate according to the present embodiment, in the case where the average thermal expansion coefficient is too large, a difference in expansion between the glass plate and a support member or the like becomes large, which may cause distortion, and the glass plate may be cracked. The average thermal expansion coefficient of the glass plate according to the present embodiment at 50° C. to 350° C. may be 70×10⁻⁷/K or less, and is preferably 68×10⁻⁷/K or less, more preferably 65×10⁻⁷/K or less, and still more preferably 60×10⁻⁷/K or less.

A density of the glass plate according to the present embodiment may be 2.2 g/cm³ or more and 2.6 g/cm³ or less. A Young's modulus of the glass plate according to the present embodiment may be 60 GPa or more and 90 GPa or less. In the case where the glass plate according to the present embodiment satisfies these conditions, the glass plate can be suitably used as the window glass for a vehicle, the window glass for a building, or the like.

The glass plate according to the present embodiment preferably contains a certain amount or more of SiO₂ in order to ensure the weather resistance, and as a result, the density of the glass plate according to the present embodiment may be 2.2 g/cm³ or more. The density of the glass plate according to the present embodiment is preferably 2.3 g/cm³ or more. In the case where the density is 2.2 g/cm³ or more, a sound insulation property in a room and a vehicle is improved.

In addition, in the case where the density of the glass plate according to the present embodiment is 2.6 g/cm³ or less, the glass plate is less likely to become brittle, and a high sound insulation property can be maintained. The density of the glass plate according to the present embodiment is preferably 2.5 g/cm³ or less.

The glass plate according to the present embodiment has a high rigidity as the Young's modulus increases, and becomes more suitable for the window glass for a vehicle or the like. The Young's modulus of the glass plate according to the present embodiment is preferably 65 GPa or more, more preferably 70 GPa or more, further preferably 72 GPa or more, still more preferably 74 GPa or more, even still more preferably 75 GPa or more, particularly preferably 77 GPa or more, and most preferably 80 GPa or more.

On the other hand, in the case where Al₂O₃ or MgO is increased in order to increase the Young's modulus, the relative dielectric constant (εₜ) and the loss tangent (tan δ) of the glass increase, and therefore, the millimeter radio wave transmissivity may decrease. Therefore, in the glass plate according to the present embodiment, the content of Al₂O₃ or MgO may be adjusted, and an appropriate Young's modulus is 90 GPa or less, more preferably 88 GPa or less, and still more preferably 86 GPa or less.

In addition, in the glass plate according to the present embodiment, T_{g} is preferably 450° C. or higher and 600° C. or lower. In the present description, T_{g} represents a glass transition point of the glass. In the case where T_{g} is within this predetermined temperature range, the bending processing of the glass can be performed within a normal producing condition range. In the case where T_{g} of the glass plate according to the present embodiment is lower than 450° C., there is no problem in the formability, but an alkali content or an alkaline earth content becomes too large, and problems that the millimeter radio wave transmissivity is decreased, thermal expansion of the glass is excessive, the weather resistance is decreased, and the like are likely to occur. In addition, in the case where T_{g} of the glass plate according to the present embodiment is lower than 450° C., the glass may devitrify and may not be formed in a forming temperature range.

T_{g} of the glass plate according to the present embodiment is more preferably 470° C. or higher, still more preferably 490° C. or higher, and particularly preferably 510° C. or higher.

On the other hand, in the case where T_{g} is too high, productivity decreases due to high-temperature control during glass bending processing, and therefore, T_{g} of the glass plate according to the present embodiment is more preferably 590° C. or less, still more preferably 580° C. or less, and particularly preferably 570° C. or less.

The glass plate according to the present embodiment may contain components (hereinafter, also referred to as “other components”) other than SiO₂, Al₂O₃, B₂O₃, MgO, CaO, SrO, BaO, ZnO, Li₂O, Na₂O, K₂O, and Fe₂O₃, and in the case where the other components are contained, a total content thereof is preferably 5.0% or less.

Examples of the other components include, for example, P₂O₅, ZrO₂, Y₂O₃, TiO₂, CeO₂, Nd₂O₅, GaO₂, GeO₂, MnO₂, CoO, Cr₂O₃, V₂O₅, Se, Au₂O₃, Ag₂O, CuO, CdO, SO₃, Cl, F, SnO₂, Sb₂O₃, and NiO, and the other components may be metal ions or oxides.

The other components may be contained in an amount of 5.0% or less for various purposes (for example, refining and coloring). In the case where a total content of the other components is more than 5.0%, the millimeter radio wave transmissivity may be decreased. The total content of the other components is preferably 2.0% or less, more preferably 1.0% or less, still more preferably 0.50% or less, particularly preferably 0.30% or less, and most preferably 0.10% or less. In order to prevent an influence on the environment, each of a content of As₂O₃ and a content of PbO is preferably less than 0.0010%.

The glass plate according to the present embodiment may contain P₂O₅. A content of P₂O₅ maybe 0.0% or more and 10% or less. P₂O₅ has a function of decreasing the glass viscosity. In the case where P₂O₅ is contained in the glass plate according to the present embodiment, the content thereof is preferably 0.2% or more, more preferably 0.5% or more, still more preferably 0.8% or more, and particularly preferably 1.0% or more.

On the other hand, P₂O₅ tends to cause defects in the glass in a float bath in the case where the glass plate according to the present embodiment is produced with a float method. Therefore, the content of P₂O₅ in the glass plate according to the present embodiment is preferably 5.0% or less, more preferably 4.0% or less, still more preferably 3.0% or less, and particularly preferably 2.0% or less.

The glass plate according to the present embodiment may contain Cr₂O₃. Cr₂O₃ acts as an oxidant to control an amount of FeO. In the case where the glass plate according to the present embodiment contains Cr₂O₃, a content thereof is preferably 0.0020% or more, and more preferably 0.0040% or more.

Since Cr₂O₃ has coloring in light in a visible region, the visible light transmittance may be decreased. Therefore, in the case where the glass plate according to the present embodiment contains Cr₂O₃, the content thereof is preferably 1.0% or less, more preferably 0.50% or less, still more preferably 0.30% or less, and particularly preferably 0.10% or less.

The glass plate according to the present embodiment may contain SnO₂. SnO₂ acts as a reducing agent to control the amount of FeO. In the case where the glass plate according to the present embodiment contains SnO₂, a content thereof is preferably 0.010% or more, more preferably 0.040% or more, still more preferably 0.060% or more, and particularly preferably 0.080% or more.

On the other hand, in order to prevent defects due to SnO₂ at the time of producing the glass plate, the content of SnO₂ in the glass plate according to the present embodiment is preferably 1.0% or less, more preferably 0.50% or less, still more preferably 0.30% or less, and particularly preferably 0.20% or less.

The glass plate according to the present embodiment may contain NiO, but in the case where NiO is contained, formation of NiS may cause glass breakage. Therefore, a content of NiO is preferably 0.010% or less, and more preferably 0.0050% or less, and it is still more preferable that the glass plate be substantially free of NiO.

The glass plate according to the present embodiment may contain TiO₂. Since TiO₂ has absorption in an ultraviolet region, it is possible to reduce the ultraviolet transmittance Tuv and improve the UV cut performance. In the case where the glass plate according to the present embodiment contains TiO₂, a content thereof is preferably 0.010% or more, more preferably 0.040% or more, still more preferably 0.075% or more, and particularly preferably 0.15% or more. Since TiO₂ has coloring in light in a visible region, the transmittance in a visible region may be decreased. In the case where the glass plate according to the present embodiment contains TiO₂, the content thereof is preferably 0.80% or less, more preferably 0.50% or less, still more preferably 0.40% or less, and particularly preferably 0.30% or less.

The glass plate according to the present embodiment may contain CeO₂. Since CeO₂ has absorption in an ultraviolet region, it is possible to reduce the ultraviolet transmittance Tuv and improve the UV cut performance. In the case where the glass plate according to the present embodiment contains CeO₂, a content thereof is preferably 0.010% or more, more preferably 0.020% or more, still more preferably 0.040% or more, and particularly preferably 0.070% or more. CeO₂ absorbs light in an ultraviolet region to cause solarization, and the transmittance in a visible region may be decreased. In the case where the glass plate according to the present embodiment contains CeO₂, the content thereof is preferably 0.25% or less, more preferably 0.18% or less, still more preferably 0.14% or less, and particularly preferably 0.10% or less.

The glass plate according to the present embodiment preferably has a sufficient visible light transmittance, and when a thickness of the glass plate is converted into 2.00 mm, a visible light transmittance Tv defined by ISO-9050:2003 using a D65 light source is preferably 75% or more. Tv is preferably 77% or more, and more preferably 80% or more. In addition, Tv is, for example, 90% or less.

The glass plate according to the present embodiment preferably has a high heat insulation property, and when the thickness is converted into 2.00 mm, a total solar transmittance Tts defined by ISO-13837:2008 convention A and measured at a wind speed of 4 m/s is preferably 88% or less. Tts is preferably 80% or less, and more preferably 78% or less. In addition, Tts is, for example, 70% or more.

The glass plate according to the present embodiment preferably has a low ultraviolet transmission, and when the thickness is converted into 2.00 mm, the ultraviolet transmittance Tuv defined by ISO-9845A is preferably 80% or less. Tuv is more preferably 70% or less, still more preferably 60% or less, and particularly preferably 50% or less. In addition, Tuv is, for example, 10% or more.

In the glass plate according to the present embodiment, when the thickness is converted into 2.00 mm, a* defined by JIS Z 8781-4 using a D65 light source is preferably −5.0 or more, more preferably −3.0 or more, and still more preferably −2.0 or more. In addition, a* is preferably 2.0 or less, more preferably 1.0 or less, and still more preferably 0 or less.

In the glass plate according to the present embodiment, when the thickness is converted into 2.00 mm, b* defined by JIS Z 8781-4 using a D65 light source is preferably −5.0 or more, more preferably −3.0 or more, and still more preferably −1.0 or more. In addition, b* is preferably 5.0 or less, more preferably 4.0 or less, and still more preferably 3.0 or less. In the case where a* and b* are within the above ranges, the glass plate according to the present embodiment is excellent in design as the window glass for a building or the window glass for a vehicle.

A method for producing the glass plate according to the present embodiment is not particularly limited, and for example, a glass plate formed with a known float method is preferred. In the float method, a molten glass base material is floated on a molten metal such as tin, and a glass plate having a uniform thickness and width is formed under strict temperature control. Alternatively, a glass plate formed with a known roll-out method or down draw method may be used, or a glass plate having a polished surface and a uniform thickness may be used. Here, the down draw method is roughly classified into a slot down draw method and an overflow down draw method (fusion method), and both of the methods are methods in which a molten glass is continuously poured down from a formed body to form a glass ribbon in a band plate shape.

The glass plate according to the present embodiment may be subjected to thermal strengthening. A thermal strengthened glass is obtained by subjecting the glass plate to a heat strengthening treatment. In the heat strengthening treatment, the uniformly heated glass plate is rapidly cooled from a temperature near a softening point, and a compressive stress is generated on a surface of the glass due to a temperature difference between the surface of the glass and an inside of the glass. The compressive stress is generated uniformly over the entire surface of the glass, and a compressive stress layer having a uniform depth is formed over the entire surface of the glass. The heat strengthening treatment is more suitable for strengthening a thick glass plate than a chemical strengthening treatment.

Normally, a glass having a low alkali content or containing no alkali has a small average thermal expansion coefficient, and thus there is a problem that it is difficult to apply the thermal strengthening. However, the glass plate according to the present embodiment has an average thermal expansion coefficient larger than that of a glass plate having a low alkali content or a glass plate containing no alkali in the related art, and thus can be subjected to the thermal strengthening.

[Laminated Glass]

A laminated glass according to an embodiment of the present invention includes: a first glass plate; a second glass plate; and an interlayer sandwiched between the first glass plate and the second glass plate. At least one of the first glass plate and the second glass plate is the above glass plate.

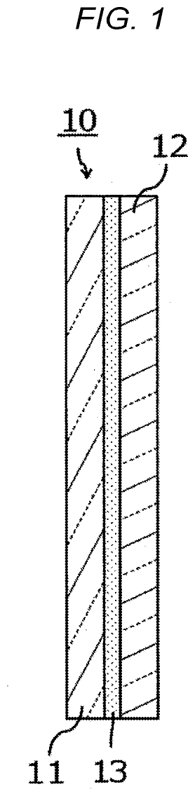

FIG. 1 is a view illustrating an example of a laminated glass 10 according to the present embodiment. The laminated glass 10 includes a first glass plate 11, a second glass plate 12, and an interlayer 13 sandwiched between the first glass plate 11 and the second glass plate 12.

The laminated glass 10 according to the present embodiment is not limited to an aspect of FIG. 1, and can be modified without departing from the gist of the present invention. For example, the interlayer 13 may be formed as one layer as illustrated in FIG. 1, or may be formed as two or more layers. In addition, the laminated glass 10 according to the present embodiment may include three or more glass plates, and in this case, an organic resin or the like may be interposed between adjacent glass plates.

Hereinafter, the laminated glass 10 according to the present embodiment will be described as a configuration in which only two glass plates, that is, the first glass plate 11 and the second glass plate 12 are included, and the interlayer 13 is sandwiched therebetween.

In the laminated glass according to the present embodiment, it is preferable to use the above glass plate for both the first glass plate 11 and the second glass plate 12 from viewpoints of radio wave transmissivity and bending processability. In this case, the first glass plate 11 and the second glass plate 12 may be glass plates having the same composition or glass plates having different compositions.

In the case where one of the first glass plate 11 and the second glass plate 12 is not the above glass plate, a type of the glass plate is not particularly limited, and a known glass plate in the related art used for the window glass for a vehicle or the like may be used. Specific examples thereof include an alkali aluminosilicate glass and a soda lime glass. These glass plates may be colored to such an extent that transparency thereof is not impaired, or may not be colored.

In addition, in the laminated glass according to the present embodiment, one of the first glass plate 11 and the second glass plate 12 may be an alkali aluminosilicate glass containing 1.0% or more of Al₂O₃. By using the above alkali aluminosilicate glass as the first glass plate 11 or the second glass plate 12, chemical strengthening can be performed as described later, and a strength can be increased.

From viewpoints of the weather resistance and the chemical strengthening, a content of Al₂O₃ in the above alkali aluminosilicate glass is preferably 2.0% or more, more preferably 2.5% or more, still more preferably 10% or more, particularly preferably 12% or more, and most preferably 13% or more.

In addition, in the alkali aluminosilicate glass, in the case where the content of Al₂O₃ is large, the millimeter radio wave transmissivity may be decreased, and thus the content of Al₂O₃ may be 25% or less, and is preferably 20% or less, more preferably 19% or less, and still more preferably 15% or less.

Specific examples of the above alkali aluminosilicate glass include a glass having the following composition. Each component is expressed in terms of molar percentage based on oxides.
61%≤SiO₂≤77%
1.0%≤Al₂O₃≤25%
0.0%≤B₂03≤10%
0.0%≤MgO≤15%
0.0%≤CaO≤10%
0.0%≤SrO≤1.0%
0.0%≤BaO≤1.0%
0.0% Li₂0≤15%
2.0%≤Na₂O≤15%
0.0%≤K₂O≤6.0%
0.0%≤ZrO2≤4.0%
0.0% TᵢO₂≤1.0%
0.0%≤Y₂O₃≤2.0%
10%≤R₂0≤25%
0.0%≤RO≤20% (R₂O represents a total amount of Li₂O, Na₂O, and K₂O, and RO represents a total amount of MgO, CaO, SrO, and BaO.)

In addition, in the laminated glass according to the present embodiment, one of the first glass plate 11 and the second glass plate 12 may be a soda lime glass. The soda lime glass may be a soda lime glass containing less than 1.0% of Al₂O₃. Specific examples thereof include a glass having the following composition.
60%≤SiO₂≤75%
0.0%≤Al₂O₃≤1.0%
2.0%≤MgO≤11%
2.0%≤CaO≤10%
0.0%≤SrO≤3.0%
0.0%≤BaO≤3.0%
10%≤Na₂O≤18%
0.0%≤K₂O≤8.0%
0.0%≤ZrO₂≤4.0%
0.0010%≤Fe₂O₃≤5.0%

A thickness of the first glass plate 11 or the second glass plate 12 is preferably 0.50 mm or more, more preferably 0.70 mm or more, still more preferably 1.00 mm or more, particularly preferably 1.20 mm or more, and most preferably 1.50 mm or more. The thickness of the first glass plate 11 or the second glass plate 12 is preferably 0.50 mm or more from a viewpoint of impact resistance.

In addition, the thickness of the first glass plate 11 or the second glass plate 12 is preferably 3.70 mm or less, more preferably 3.50 mm or less, still more preferably 3.20 mm or less, even still more preferably 3.00 mm or less, particularly preferably 2.50 mm or less, and most preferably 2.30 mm or less. In the case where the thickness of the first glass plate 11 or the second glass plate 12 is 3.70 mm or less, a weight of the laminated glass 10 does not become too large, which is preferred from a viewpoint of improving fuel efficiency in the case of being used for a vehicle.

In addition, the first glass plate 11 and the second glass plate 12 may have the same thickness or may have different thicknesses.

In the laminated glass 10 according to the present embodiment, a total thickness of the first glass plate 11, the second glass plate 12, and the interlayer 13 is preferably 2.30 mm or more. In the case where the total thickness is 2.30 mm or more, a sufficient strength is obtained. The total thickness is more preferably 2.50 mm or more, still more preferably 2.70 mm or more, even still more preferably 3.00 mm or more, particularly preferably 3.50 mm or more, and most preferably 4.00 mm or more.

In addition, from viewpoints of improving the radio wave transmissivity and reducing a weight, the total thickness is preferably 6.00 mm or less, more preferably 5.80 mm or less, still more preferably 5.50 mm or less, and particularly preferably 5.30 mm or less.

In the laminated glass 10 according to the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 is gradually decreased.

One of the first glass plate 11 and the second glass plate 12 may be a chemically strengthened glass subjected to glass strengthening in order to improve the strength. Examples of a method of the chemical strengthening treatment include an ion exchange method. In the ion exchange method, a glass plate is immersed in a treatment liquid (for example, potassium nitrate molten salt), and ions having a small ion radius (for example, Na ions) contained in a glass are exchanged for ions having a large ion radius (for example, K ions), thereby generating a compressive stress on a surface of the glass. The compressive stress is generated uniformly over the entire surface of the glass plate, and a compressive stress layer having a uniform depth is formed over the entire surface of the glass plate.

Each of a magnitude of the compressive stress on the surface of the glass plate (hereinafter, also referred to as a surface compressive stress CS) and a depth DOL of the compressive stress layer formed on the surface of the glass plate can be adjusted by a glass composition, a chemical strengthening treatment time, and a chemical strengthening treatment temperature. Examples of the chemically strengthened glass include a glass obtained by performing the chemical strengthening treatment on the above alkali aluminosilicate glass.

A shape of the first glass plate 11 and the second glass plate 12 may be a flat plate shape, or may be a curved shape having a curvature on the entire surface or a part thereof. In the case where the first glass plate 11 and the second glass plate 12 are curved, the first glass plate 11 and the second glass plate 12 may have a single-curved shape curved only in one of an up-and-down direction and a right-and-left direction, or may have a multiple-curved shape curved in both the up-and-down direction and the right-and-left direction. In the case where the first glass plate 11 and the second glass plate 12 have the multiple-curved shape, a radius of curvature thereof may be the same or different in the up-and-down direction and the right-and-left direction. In the case where the first glass plate 11 and the second glass plate 12 are curved, the radius of curvature in the up-and-down direction and/or the right-and-left direction is preferably 1,000 mm or more. A shape of a main surface of the first glass plate 11 and the second glass plate 12 is a shape that fits a window opening of a vehicle on which the first glass plate 11 and the second glass plate 12 are to be mounted.

The interlayer 13 according to the present embodiment is sandwiched between the first glass plate 11 and the second glass plate 12. Since the laminated glass 10 according to the present embodiment includes the interlayer 13, the first glass plate 11 and the second glass plate 12 are firmly adhered to each other, and an impact force when scattered pieces collide with the glass plate can be reduced.

As the interlayer 13, various organic resins generally used for a laminated glass used as a laminated glass for a vehicle in the related art may be used. For example, polyethylene (PE), ethylene vinyl acetate copolymer (EVA), polypropylene (PP), polystyrene (PS), methacrylic resin (PMA), polyvinyl chloride (PVC), polyethylene terephthalate (PET), polybutylene terephthalate (PBT), cellulose acetate (CA), diallyl phthalate resin (DAP), urea resin (UP), melamine resin (MF), unsaturated polyester (UP), polyvinyl butyral (PVB), polyvinyl fornal (PVF), polyvinyl alcohol (PVAL), vinyl acetate resin (PVAc), ionomer (IO), polymethylpentene (TPX), vinylidene chloride (PVDC), polysulfone (PSF), polyvinylidene fluoride (PVDF), methacrylate-styrene copolymer resin (MS), polyarylate (PAR), polyarylsulfone (PASF), polybutadiene (BR), polyethersulfone (PESF), or polyether ether ketone (PEEK) may be used. Among these, EVA and PVB are suitable from viewpoints of transparency and adhesion, and PVB is particularly preferred because PVB can provide the sound insulation property.

A thickness of the interlayer 13 is preferably 0.30 mm or more, more preferably 0.50 mm or more, and still more preferably 0.70 mm or more from viewpoints of reduction in the impact force and the sound insulation property.

In addition, the thickness of the interlayer 13 is preferably 1.00 mm or less, more preferably 0.90 mm or less, and still more preferably 0.80 mm or less from a viewpoint of preventing a decrease in the visible light transmittance. In addition, the thickness of the interlayer 13 is preferably in a range of 0.30 mm to 1.00 mm, and more preferably in a range of 0.70 mm to 0.80 mm.

The thickness of the interlayer 13 may be constant over the entire surface, or may be changed for each portion as necessary.

In the case where a difference in linear expansion coefficient between the interlayer 13 and the first glass plate 11 or the second glass plate 12 is large, in the case where the laminated glass 10 is produced through a heating step to be described later, the laminated glass 10 may be cracked or warped, resulting in a poor appearance. Therefore, the difference in the linear expansion coefficient between the interlayer 13 and the first glass plate 11 or the second glass plate 12 is preferably as small as possible. The difference in the linear expansion coefficient between the interlayer 13 and the first glass plate 11 or the second glass plate 12 may be represented by a difference between average thermal expansion coefficients in a predetermined temperature range. Particularly, a resin constituting the interlayer 13 has a low glass transition point, and thus a predetermined difference in the average thermal expansion coefficient may be set in a temperature range equal to or lower than the glass transition point of the resin material. A difference in linear expansion coefficient between the resin material and the first glass plate 11 or the second glass plate 12 may be set at a predetermined temperature equal to or lower than the glass transition point of the resin material.

As the interlayer 13, an adhesive layer containing an adhesive may be used, and the adhesive is not particularly limited, and for example, an acrylic adhesive or a silicone adhesive may be used.

In the case where the interlayer 13 is the adhesive layer, it is not necessary to perform the heating step in a process of bonding the first glass plate 11 and the second glass plate 12, and thus the above cracking or warpage is less likely to occur.

[Other Layers]

The laminated glass 10 according to the embodiment of the present invention may include layers other than the first glass plate 11, the second glass plate 12, and the interlayer 13 (hereinafter, also referred to as “other layers”) within a range that does not impair effects of the present invention. For example, a coating layer that provides a water repellent function, a hydrophilic function, an anti-fogging function, or the like, and an infrared reflective film may be provided. Positions where the other layers are provided are not particularly limited, and the other layers may be provided on a surface of the laminated glass 10, or may be sandwiched between the first glass plate 11, the second glass plate 12, or the interlayer 13. In addition, the laminated glass 10 according to the present embodiment may include a black ceramic layer or the like which is disposed in a band shape on a part or all of a peripheral edge portion for a purpose of hiding an attachment portion to a frame body or the like, a wiring conductor, or the like.

A method for producing the laminated glass 10 according to the embodiment of the present invention may be the same as that for a known laminated glass in the related art. For example, through a step of laminating the first glass plate 11, the interlayer 13, and the second glass plate 12 in this order and performing heating and pressing, the laminated glass 10 having a configuration in which the first glass plate 11 and the second glass plate 12 are bonded via the interlayer 13 is obtained.

In the method for producing the laminated glass 10 according to the embodiment of the present invention, for example, after a step of heating and forming each of the first glass plate 11 and the second glass plate 12, a step of inserting the interlayer 13 between the first glass plate 11 and the second glass plate 12 and performing heating and pressing may be performed. Through such steps, the laminated glass 10 having the configuration in which the first glass plate 11 and the second glass plate 12 are bonded via the interlayer 13 may be obtained.

In the laminated glass 10 according to the embodiment of the present invention, the total thickness of the first glass plate 11, the second glass plate 12, and the interlayer 13 is 6.00 mm or less, and the visible light transmittance Tv defined by ISO-9050:2003 using a D65 light source is preferably 70% or more. Tv is more preferably 71% or more, and still more preferably 72% or more. In addition, Tv is, for example, 90% or less.

In the laminated glass 10 according to the embodiment of the present invention, the total thickness of the first glass plate 11, the second glass plate 12, and the interlayer 13 is 6.00 mm or less, and the total solar transmittance Tts defined by ISO-13837:2008 convention A and measured at a wind speed of 4 m/s is preferably 80% or less. In the case where the total solar transmittance Tts of the laminated glass 10 according to the embodiment of the present invention is 80% or less, a sufficient heat insulation property is obtained. Tts is more preferably 75% or less, still more preferably 70% or less, and particularly preferably 68% or less. In addition, Tts is, for example, 55% or more.

In the laminated glass 10 according to the embodiment of the present invention, the total thickness of the first glass plate 11, the second glass plate 12, and the interlayer 13 is 6.00 mm or less, and the ultraviolet transmittance Tuv defined by ISO-9845A is preferably 3.0% or less. In the case where the ultraviolet transmittance Tuv of the laminated glass 10 according to the embodiment of the present invention is 3.0% or less, transmission of ultraviolet light can be sufficiently blocked. Tuv is more preferably 2.8% or less, still more preferably 2.6% or less, and particularly preferably 2.5% or less. In addition, Tuv is, for example, 0.10% or more.

In the laminated glass 10 according to the embodiment of the present invention, the total thickness of the first glass plate 11, the second glass plate 12, and the interlayer 13 is 6.00 mm or less, and a maximum value of the radio wave transmission loss S21 when a radio wave having a frequency of 75 GHz to 80 GHz is incident on the first glass plate 11 at an incident angle of 60° is preferably −4.0 dB or more. The maximum value of the radio wave transmission loss S21 under the above condition is preferably −3.0 dB or more, and more preferably −2.5 dB or more. In addition, the maximum value of the radio wave transmission loss S21 under the above condition is, for example, −0.50 dB or less.

Here, the radio wave transmission loss S21 means an insertion loss derived based on a relative dielectric constant (Er) and a loss tangent (tan δ) (where δ is a loss angle) of each material used for the laminated glass, and the smaller an absolute value of the radio wave transmission loss S21 is, the higher the radio wave transmissivity is.

The incident angle means an angle of an incident direction of a radio wave from a normal line of a main surface of the laminated glass 10.

In the laminated glass 10 according to the embodiment of the present invention, the total thickness of the first glass plate 11, the second glass plate 12, and the interlayer 13 is 6.00 mm or less, and the maximum value of the radio wave transmission loss S21 when the radio wave having the frequency of 75 GHz to 80 GHz is incident on the first glass plate 11 at an incident angle of 450 is preferably −4.0 dB or more. The maximum value of the radio wave transmission loss S21 under the above condition is preferably −3.0 dB or more, and more preferably −2.5 dB or more. In addition, the maximum value of the radio wave transmission loss S21 under the above condition is, for example, −0.50 dB or less.

In the laminated glass 10 according to the embodiment of the present invention, the total thickness of the first glass plate 11, the second glass plate 12, and the interlayer 13 is 6.00 mm or less, and the maximum value of the radio wave transmission loss S21 when the radio wave having the frequency of 75 GHz to 80 GHz is incident on the first glass plate 11 at an incident angle of 200 is preferably −4.0 dB or more. The maximum value of the radio wave transmission loss S21 under the above condition is preferably −3.0 dB or more, and more preferably −2.5 dB or more. In addition, the maximum value of the radio wave transmission loss S21 under the above condition is, for example, −0.50 dB or less.

In the laminated glass 10 according to the embodiment of the present invention, the total thickness of the first glass plate 11, the second glass plate 12, and the interlayer 13 is 6.00 mm or less, and the chromaticity a* defined by JIS Z 8781-4 using a D65 light source is preferably −8.0 or more, more preferably −7.0 or more, still more preferably −6.0 or more, and particularly preferably −5.5 or more. In addition, a* is preferably 2.0 or less, more preferably 1.0 or less, and still more preferably 0 or less.

Further, the total thickness of the first glass plate 11, the second glass plate 12, and the interlayer 13 is 6.00 mm or less, and the chromaticity b* defined by JIS Z 8781-4 using a D65 light source is preferably −5.0 or more, more preferably −3.0 or more, and still more preferably −1.0 or more. In addition, b* is preferably 7.0 or less, more preferably 5.0 or less, and still more preferably 4.0 or less. In the case where a* and b* are within the above ranges, the glass plate according to the present embodiment is excellent in design as the window glass for a building and the window glass for a vehicle.

[Window Glass for Building and Window Glass for Vehicle]

A window glass for a building and a window glass for a vehicle according to the present embodiment include the above glass plate. The window glass for a building and the window glass for a vehicle according to the present embodiment may be made from the above laminated glass.

Hereinafter, an example in which the laminated glass 10 according to the present embodiment is used as the window glass for a vehicle will be described with reference to the drawings.

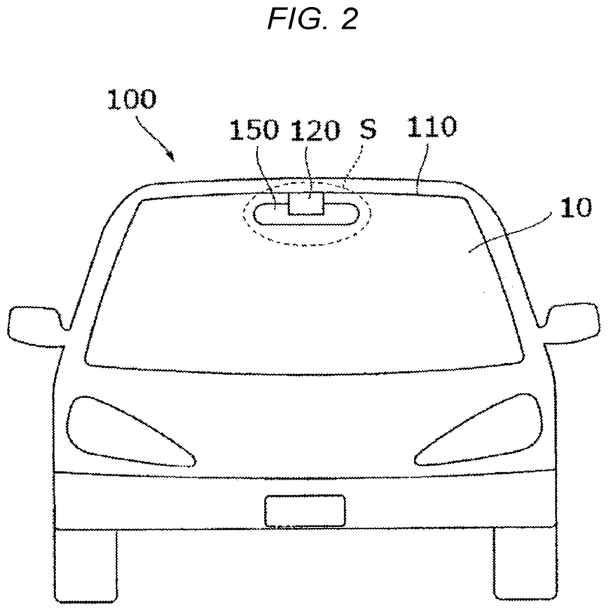

FIG. 2 is a conceptual view illustrating a state in which the laminated glass 10 according to the present embodiment is mounted on an opening 110 formed at a front part of a vehicle 100 and used as a window glass of the vehicle. In the laminated glass 10 used as the window glass of the vehicle, a housing (case) 120 in which an information device or the like is housed for ensuring traveling safety of the vehicle may be attached to a surface on an inner side of the vehicle.

The information device housed in the housing is a device that uses a camera, a radar, or the like to prevent a rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and receives a signal. The “signal” is an electromagnetic wave including a millimeter wave, a visible light, an infrared light, and the like.

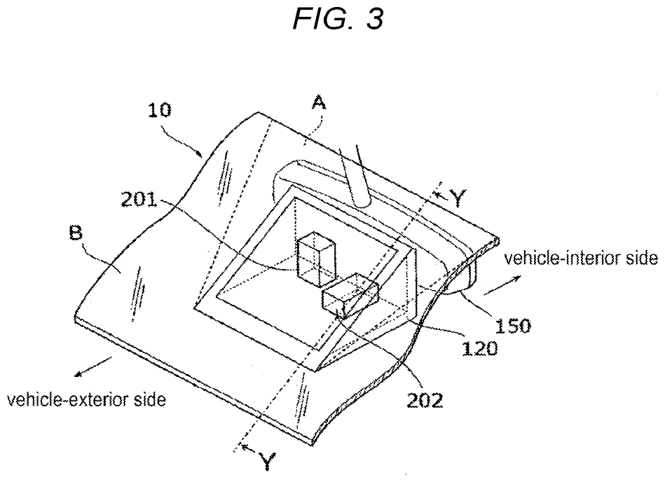

FIG. 3 is an enlarged view of a portion S in FIG. 2, and is a perspective view illustrating a portion where the housing 120 is attached to the laminated glass 10 according to the present embodiment. The housing 120 stores a millimeter wave radar 201 and a stereo camera 202 as the information device. The housing 120 in which the information device is stored is normally attached to a vehicle outer side with respect to a back mirror 150 and a vehicle inner side with respect to the laminated glass 10, and may be attached to another portion.

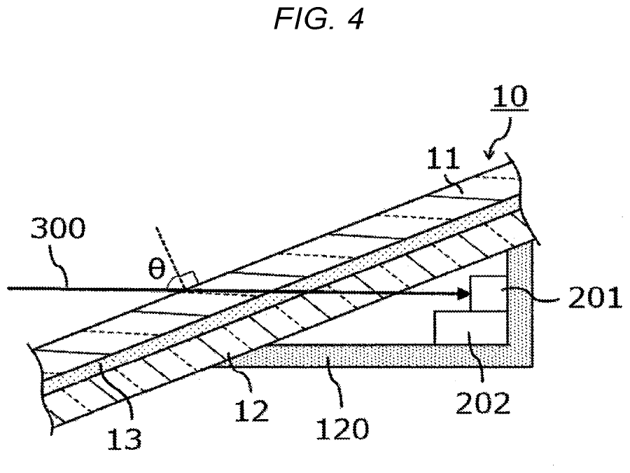

FIG. 4 is a cross-sectional view including a line Y-Y in FIG. 3 in a direction orthogonal to a horizontal line. The first glass plate 11 of the laminated glass 10 is disposed on the vehicle outer side. As described above, an incident angle θ of a radio wave 300 used for communication of the information device such as the millimeter wave radar 201 with respect to the main surface of the first glass plate 11 may be evaluated as, for example, 20°, 45°, or 60° as described above.

### EXAMPLES

Hereinafter, the present invention will be specifically described with reference to Examples, but the present invention is not limited thereto.

<Production of Glass Plates of Examples 1 to 11>

Raw materials were charged into a platinum crucible so as to obtain each glass composition (unit: mol %) shown in Table 1, and melted at 1,650° C. for 3 hours to obtain each molten glass. Each molten glass was poured onto a carbon plate and slowly cooled. Both surfaces of each obtained plate-shaped glass were polished to obtain a glass plate having a thickness of 2.00 mm. Examples 1 to 3 are comparative examples, and Examples 4 to 11 are inventive examples.

Methods for determining numerical values shown in Table 1 are shown below.

### (1) Glass Transition Point (T_{g}):

The glass transition point is a value measured using TMA and determined according to a standard of JTS R3103-3 (2001).

### (2) Average Thermal Expansion Coefficient at 50° C. to 350° C. (CTE (50 to 350)):

The average thermal expansion coefficient was measured using a differential thermal dilatometer (TMA) and was determined according to a standard of JIS R3102 (1995).

### (3) Viscosity:

A temperature T₂ (reference temperature of melting property) at which the viscosity η was 10² dPa·s was measured using a rotational viscometer. A temperature T₁₂ (reference temperature of bending processability) at which the viscosity η was 10¹² dPa·s was measured with a beam bending method.

### (4) Density:

About 20 g of a glass mass containing no foam and cut out from the glass plate was measured with Archimedes method.

### (5) Young's Modulus:

The Young's modulus was measured at 25° C. with an ultrasonic pulse method (Olympus, DL35).

### (6) Relative Dielectric Constant (Fr) and Loss Tangent (tan δ):

The relative dielectric constant (Fr) and the loss tangent (tan δ) at a frequency of 10 GHz were measured under a condition of 1° C./min slow cooling with a method (SPDR method) using a split post dielectric resonator manufactured by QWED Company.

### (7) Visible Light Transmittance (Tv):

Tv, when a thickness of the glass plate was converted into 2.00 mm, was measured with a method defined by ISO-9050:2003 using a D65 light source. Tv was measured using a spectrophotometer LAMBDA 950 manufactured by Perkinelmer.

### (8) Total Solar Transmittance (Tts):

Tts, when a thickness of the glass plate was converted into 2.00 mm, was determined with a method defined by ISO-13837:2008 convention A and measured at a wind speed of 4 m/s. Tts was measured using a spectrophotometer LAMBDA 950 manufactured by Perkinelmer.

### (9) Ultraviolet Transmittance (Tuv):

Tuv, when a thickness of the glass plate was converted into 2.00 mm, was measured with a method defined by ISO-9845A. Tuv was measured using a spectrophotometer LAMBDA 950 manufactured by Perkinelmer.

### (10) Chromaticity (a*, b*):

The chromaticities a* and b* defined by JIS Z 8781-4 were measured using a D65 light source.

Measurement results are shown in Table 1.

TABLE 1

| mol % | Ex. 1 | Ex. 2 | Ex. 3 | Ex. 4 | Ex. 5 | Ex. 6 |
|---|---|---|---|---|---|---|
| SiO₂ | 69.54 | 65.96 | 83.40 | 71.87 | 73.86 | 73.86 |
| Al₂O₃ | 0.90 | 10.99 | 1.20 | 3.99 | 3.99 | 3.99 |
| B₂O₃ | 0.00 | 7.50 | 11.59 | 0.00 | 0.00 | 0.00 |
| MgO | 7.09 | 5.70 | 0.00 | 2.00 | 2.00 | 3.99 |
| CaO | 9.09 | 4.90 | 0.00 | 13.97 | 13.97 | 9.98 |
| SrO | 0.00 | 4.90 | 0.00 | 0.00 | 0.00 | 0.00 |
| BaO | 0.00 | 0.04 | 0.00 | 0.00 | 0.00 | 0.00 |
| ZnO | 0.00 | 0.00 | 0.00 | 0.00 | 0.00 | 0.00 |
| Li₂O | 0.00 | 0.00 | 0.00 | 6.99 | 4.99 | 6.99 |
| Na₂O | 12.59 | 0.00 | 3.30 | 0.50 | 1.00 | 0.50 |
| K₂O | 0.60 | 0.00 | 0.50 | 0.50 | 0.00 | 0.50 |
| Fe₂O₃ | 0.18 | 0.02 | 0.02 | 0.18 | 0.19 | 0.18 |
| Total | 100 | 100 | 100 | 100 | 100 | 100 |
| RO | 16.2 | 15.5 | 0.0 | 16.0 | 16.0 | 14.0 |
| R₂O | 13.2 | 0.0 | 3.8 | 8.0 | 6.0 | 8.0 |
| Thickness [mm] | 2.00 | 2.00 | 2.00 | 2.00 | 2.00 | 2.00 |
| T_{g} (TMA) [° C.] | 549 | 710 | 525 | 563 | 587 | 562 |
| CTE (50 to 350) | 91 | 38 | 33 | 67 | 59 | 64 |
| [×10⁻⁷/K] | | | | | | |
| T₂ [° C.] | 1,464 | 1,645 | 1,850 | ≤1,650 | 1,602 | 1,602 |
| T₁₂ [° C.] | 590 | 769 | 600 | 611 | 677 | 628 |
| Density [g/cm³] | 2.50 | 2.50 | 2.23 | 2.48 | 2.47 | 2.44 |
| Young's modulus | 74 | 76 | 64 | 86 | 85 | 85 |
| [GPa] | | | | | | |
| εᵣ@10 GHz | 6.94 | 5.38 | 4.46 | 6.23 | 5.90 | 5.92 |
| @SPDR method [—] | | | | | | |
| tan δ@10 GHz | 0.0125 | 0.0049 | 0.080 | 0.0085 | 0.0079 | 0.0087 |
| @SPDR method [—] | | | | | | |
| Tv@2.00 mmt (ISO- | 86 | 91 | 94 | 85 | 84 | 85 |
| 9050:2003) [%] | | | | | | |
| Tts@2.00 mmt (ISO- | 78 | 90 | 95 | 81 | 80 | 80 |
| 13837:2008) [%] | | | | | | |
| Tuv@2.00 mmt | 47 | 67 | 87 | 44 | 42 | 47 |
| (ISO-9845A) [%] | | | | | | |
| a* (D65)@2.00 mmt | −2.6 | −0.2 | −0.1 | −2.3 | −2.5 | −2.4 |
| b* (D65)@2.00 mmt | 0.3 | 0.3 | 0.2 | 1.2 | 1.4 | 1.1 |

| mol % | Ex. 7 | Ex. 8 | Ex. 9 | Ex. 10 | Ex. 11 |
|---|---|---|---|---|---|
| SiO₂ | 78.36 | 75.36 | 74.37 | 70.87 | 75.35 |
| Al₂O₃ | 2.50 | 2.99 | 2.99 | 3.99 | 1.00 |
| B₂O₃ | 0.00 | 0.00 | 0.00 | 2.99 | 13.97 |
| MgO | 6.49 | 6.49 | 7.49 | 3.99 | 2.00 |
| CaO | 4.99 | 6.99 | 6.99 | 9.98 | 0.00 |
| SrO | 0.00 | 0.00 | 0.00 | 0.00 | 0.00 |
| BaO | 0.00 | 0.00 | 0.00 | 0.00 | 0.00 |
| ZnO | 0.00 | 0.00 | 0.00 | 0.00 | 0.00 |
| Li₂O | 6.99 | 6.99 | 6.99 | 6.99 | 2.50 |
| Na₂O | 0.25 | 0.50 | 0.50 | 0.50 | 2.50 |
| K₂O | 0.25 | 0.50 | 0.50 | 0.50 | 2.50 |
| Fe₂O₃ | 0.18 | 0.18 | 0.18 | 0.18 | 0.19 |
| Total | 100 | 100 | 100 | 100 | 100 |
| RO | 11.5 | 13.5 | 14.5 | 14.0 | 2.0 |
| R₂O | 7.5 | 8.0 | 8.0 | 8.0 | 7.5 |
| Thickness [mm] | 2.00 | 2.00 | 2.00 | 2.00 | 2.00 |
| T_{g} (TMA) [° C.] | 535 | 541 | 543 | 547 | 512 |
| CTE (50 to 350) | 50 | 57 | 57 | 60 | 46 |
| [×10⁻⁷/K] | | | | | |
| T₂ [° C.] | ≤1,650 | ≤1,650 | 1,616 | ≤1,650 | 1,638 |
| T₁₂ [° C.] | 720 | 666 | 600 | 631 | 584 |
| Density [g/cm³] | 2.38 | 2.42 | 2.43 | 2.45 | 2.28 |
| Young's modulus | 84 | 84 | 84 | 84 | 70 |
| [GPa] | | | | | |
| εᵣ@10 GHz | 5.29 | 5.70 | 5.78 | 5.90 | 4.92 |
| @SPDR method [—] | | | | | |
| tan δ@10 GHz | 0.0075 | 0.0087 | 0.0087 | 0.0084 | 0.0069 |
| @SPDR method [—] | | | | | |
| Tv@2.00 mmt (ISO- | 84 | 84 | 84 | 84 | 84 |
| 9050:2003) [%] | | | | | |
| Tts@2.00 mmt (ISO- | 79 | 79 | 79 | 80 | 80 |
| 13837:2008) [%] | | | | | |
| Tuv@2.00 mmt | 46 | 48 | 48 | 39 | 46 |
| (ISO-9845A) [%] | | | | | |
| a* (D65)@2.00 mmt | −2.7 | −2.6 | −2.6 | −2.2 | −2.5 |
| b* (D65)@2.00 mmt | 1.3 | 0.9 | 0.8 | 1.2 | 1.0 |

In each of the glass plates of Examples 4 to 11 corresponding to inventive examples, a relative dielectric constant (εᵣ) at a frequency of 10 GHz was 6.5 or less, and a loss tangent (tan δ) at a frequency of 10 GHz was 0.0090 or less, which exhibited a good radio wave transmissivity. In addition, it was found that the temperature T₂ at which the viscosity T was 10² dPa·s was 1,650° C. or less, the temperature T₁₂ at which the viscosity η was 10¹² dPa·s was 730° C. or less, the melting temperature and the bending forming temperature were low, and the processability was excellent.

On the other hand, in the glass plate of Example 1 corresponding to a comparative example, a content of R₂O was large, and thus a relative dielectric constant (Er) at a frequency of 10 GHz was more than 6.5, a loss tangent (tan δ) at the frequency of 10 GHz was more than 0.0090, and the radio wave transmissivity was poor.

In addition, in the glass plate of Example 2 corresponding to a comparative example, a content of Al₂O₃ was large and R₂O was 3.0% or less, and therefore, the temperature T₁₂ at which the viscosity η was 10¹² dPa·s exceeded 730° C., and the bending processability was poor.

In addition, the glass plate of Example 3 corresponding to a comparative example was free of MgO and Li₂O, and therefore, the temperature T₂ at which the viscosity η was 10² dPa·s exceeded 1,650° C., and it was found that the melting property of the glass plate was poor.

<Production of Laminated Glasses>

Laminated glasses of Production Examples 1 to 14 were produced by the following procedure. Production Example 1 is a comparative example, and Production Examples 2 to 14 are inventive examples.

### Production Example 1

A glass plate (Example 1) having a thickness of 2.00 mm and a composition shown in Table 1 was used as a first glass plate and a second glass plate. Polyvinyl butyral having a thickness of 0.76 mm was used as an interlayer. The first glass plate, the interlayer, and the second glass plate were laminated in this order, and subjected to a compression-bonding treatment (1 MPa, 130° C., 3 hours) using an autoclave to produce a laminated glass of Production Example 1. In the laminated glass of Production Example 1, a total thickness of the first glass plate, the second glass plate, and the interlayer was 4.76 mm.

### Production Examples 2 to 14

The laminated glasses of Production Examples 2 to 14 were produced in the same manner as in Production Example 1 except for items shown in Table 2.

[Optical Properties]

The visible light transmittance (Tv) was measured with a method defined by ISO-9050:2003 using a D65 light source in the same manner as described above.

The total solar transmittance (Tts) was measured with a method defined by ISO-13837:2008 convention A and measured at a wind speed of 4 m/s in the same manner as described above.

The ultraviolet transmittance (Tuv) was measured with a method defined by ISO-9845A in the same manner as described above.

As for the chromaticity (a*, b*), the chromaticities a* and b* defined by JIS Z 8781-4 were measured using a D65 light source in the same manner as described above.

The results are shown in Table 2.

[Radio Wave Transmissivity]

For each of the laminated glasses of Production Examples 1 to 14, a radio wave transmission loss S21 when a TM wave having a frequency of 76 GHz, 77 GHz, 78 GHz, or 79 GHz was incident at an incident angle of 20°, 45°, or 60° was calculated based on the relative dielectric constant (εᵣ) and the loss tangent (tan δ) of each material used. Specifically, antennas were opposed to each other, and each of the obtained laminated glasses was placed between the antennas so that an incident angle was 0° to 60°. Then, for TM waves having a frequency of 76 GHz and 79 GHz, the radio wave transmission loss S21 was measured when a value of a case where there was no radio wave transmissive substrate at an opening of 100 mm≤D was set to 0 [dB], and the radio wave transmissivity was evaluated according to the following criteria.

<Evaluation of Radio Wave Transmissivity>
A: −1.5 [dB]≤S21
B: −2.0 [dB]≤S21≤−1.5 [dB]
C: −2.5 [dB]≤S21≤−2.0 [dB]
D: −3.0 [dB]≤S21≤−2.5 [dB]
E: −4.0 [dB]≤S21≤−3.0 [dB]
x: S21≤−4.0 [dB]

The results are shown in Table 2.

TABLE 2

| | | Production | Production | Production | Production | Production | Production | Production |
|---|---|---|---|---|---|---|---|---|
| | | example 1 | example 2 | example 3 | example 4 | example 5 | example 6 | example 7 |
| First glass | Thickness | 2.00 mm | 2.00 mm | 2.00 mm | 2.00 mm | 1.80 mm | 2.00 mm | 2.30 mm |
| plate | Glass material | Example 1 | Example 3 | Example 6 | Example 6 | Example 6 | Example 6 | Example 6 |
| Interlayer | Thickness | 0.76 mm | 0.76 mm | 0.76 mm | 0.76 mm | 0.76 mm | 0.76 mm | 0.76 mm |
| | Resin material | PVB | PVB | PVB | PVB | PVB | PVB | PVB |
| Second | Thickness | 2.00 mm | 2.00 mm | 2.00 mm | 1.60 mm | 1.80 mm | 1.80 mm | 2.30 mm |
| glass plate | Glass material | Example 1 | Example 3 | Example 6 | Example 6 | Example 6 | Example 6 | Example 6 |
| Optical | Tv (ISO- | 80 | 92 | 78 | 79 | 79 | 79 | 76 |
| properties | 9050:2003) [%] | | | | | | | |
| | Tts (ISO- | 66 | 87 | 66 | 68 | 68 | 67 | 64 |
| | 13837:2008) [%] | | | | | | | |
| | Tuv (ISO-9845A) | 0 | 4 | 2 | 3 | 3 | 2 | 2 |
| | [%] | | | | | | | |
| | a* (D65) | −5.2 | −0.3 | −4.8 | −4.4 | −4.4 | −4.6 | −5.4 |
| | b* (D65) | 1.2 | 0.8 | 2.6 | 2.4 | 2.4 | 2.5 | 2.8 |

| | | | | | | | |
|---|---|---|---|---|---|---|---|
| Radio wave transmissivity 76 | x | A | x | C | B | E | B |
| GHz-20° | | | | | | | |
| Radio wave transmissivity 76 | x | A | D | C | A | B | D |
| GHz-45° | | | | | | | |
| Radio wave transmissivity 76 | x | A | B | B | A | A | C |
| GHz-60° | | | | | | | |
| Radio wave transmissivity 79 | x | A | x | C | E | x | B |
| GHz-20° | | | | | | | |
| Radio wave transmissivity 79 | x | A | E | B | A | D | B |
| GIIz-45° | | | | | | | |
| Radio wave transmissivity 79 | x | A | C | B | A | B | C |
| GHz-60° | | | | | | | |

| | | Production | Production | Production | Production | Production | Production | Production |
|---|---|---|---|---|---|---|---|---|
| | | example 8 | example 9 | example 10 | example 11 | example 12 | example 13 | example 14 |
| First glass | Thickness | 2.00 mm | 2.00 mm | 2.00 mm | 1.80 mm | 2.00 mm | 2.30 mm | 2.00 mm |
| plate | Glass material | Example 8 | Example 9 | Example 9 | Example 9 | Example 9 | Example 9 | Example 11 |
| Interlayer | Thickness | 0.76 mm | 0.76 mm | 0.76 mm | 0.76 mm | 0.76 mm | 0.76 mm | 0.76 mm |
| | Resin material | PVB | PVB | PVB | PVB | PVB | PVB | PVB |
| Second | Thickness | 2.00 mm | 2.00 mm | 1.60 mm | 1.80 mm | 1.80 mm | 2.30 mm | 2.00 mm |
| glass plate | Glass material | Example 8 | Example 9 | Example 9 | Example 9 | Example 9 | Example 9 | Example 11 |
| Optical | Tv (ISO- | 77 | 77 | 78 | 78 | 77 | 75 | 80 |
| properties | 9050:2003) [%] | | | | | | | |
| | Tts (ISO- | 65 | 64 | 66 | 66 | 65 | 62 | 74 |
| | 13837:2008) [%] | | | | | | | |
| | Tuv (ISO-9845A) | 2 | 2 | 3 | 3 | 2 | 2 | 3 |
| | [%] | | | | | | | |
| | a* (D65) | −5.2 | −5.3 | −4.8 | −4.8 | −5.1 | −6.0 | −1.8 |
| | b* (D65) | 2.2 | 2.1 | 1.9 | 1.9 | 2.0 | 2.2 | 3.5 |

| | | | | | | | |
|---|---|---|---|---|---|---|---|
| Radio wave transmissivity 76 | x | x | C | A | D | C | A |
| GHz-20° | | | | | | | |
| Radio wave transmissivity 76 | C | C | C | A | A | E | A |
| GHz-45° | | | | | | | |
| Radio wave transmissivity 76 | B | B | B | A | A | C | A |
| GHz-60° | | | | | | | |
| Radio wave transmissivity 79 | x | x | B | C | x | B | D |
| GHz-20° | | | | | | | |
| Radio wave transmissivity 79 | E | E | B | A | C | C | A |
| GHz-45° | | | | | | | |
| Radio wave transmissivity 79 | B | B | B | A | B | C | A |
| GHz-60° | | | | | | | |

In each of the laminated glasses of Production Examples 2 to 14 corresponding to inventive examples, the total solar transmittance Tts was 80% or less, and a good heat insulation property was exhibited.

In each of the laminated glasses of Production Examples 2 to 14, a maximum value of the radio wave transmission loss S21 at a frequency of 75 GHz to 80 GHz at an incident angle of 20°, 45°, or 60′ was −4.0 v or more, and the radio wave transmissivity was excellent.

As described above, it was found that each of the laminated glasses of Production Examples 2 to 14 had high millimeter wave transmissivity and a predetermined heat insulation property.

On the other hand, in the laminated glass of Production Example 1 corresponding to a comparative example, the radio wave transmission loss S21 at a frequency of 76 GHz and 79 GHz at an incident angle of each of 20°, 45°, and 60° was less than −4.0 dB. Although not shown in Table 2, the maximum value of the radio wave transmission loss S21 at a frequency of 75 GHz to 80 GHz at an incident angle of each of 20°, 45°, or 60° was less than −4.0 dB, and the radio wave transmissivity was poor.

Although various embodiments have been described above with reference to the drawings, it is needless to say that the present invention is not limited to such examples. It is apparent to those skilled in the art that various changes and modifications can be conceived within the scope of the claims, and it is also understood that such changes and modifications belong to the technical scope of the present invention. Constituent elements in the embodiments described above may be combined freely within a range not departing from the spirit of the invention.

The present application is based on Japanese Patent Application No. 2021-109448 filed on Jun. 30, 2021, the contents of which are incorporated herein by reference.

### REFERENCE SIGNS LIST

10: laminated glass
11: first glass plate
12: second glass plate
13: interlayer
100: vehicle
110: opening
120: housing
150: back mirror
201: millimeter wave radar
202: stereo camera
300: radio wave

What is claimed is:

1. A glass plate comprising, in terms of molar percentage based on oxides:
70%≤SiO₂≤85%;
0.0%≤Al₂O₃≤10%;
0.0%≤B₂03≤15%;
1.5%≤MgO≤20%;
0.0%≤CaO 20%;
0.0%≤SrO 5.0%;
0.0%≤BaO≤1.0%;
0.0%≤ZnO≤5.0%;
1.0%≤Li₂O≤11%;
0.0%≤Na₂O≤10%;
0.0% K₂O≤10%;
3.0%≤R₂O≤1%;
0.01%≤Fe₂O₃≤1.00%; and
2.0%≤RO≤20%,
wherein R₂O represents a total amount of Li₂O, Na₂O, and K₂O, and RO represents a total amount of MgO, CaO, SrO, and BaO,
a temperature T₂ at which a glass viscosity is 10² dPa·s is 1,650° C. or lower,
a temperature T₁₂ at which a glass viscosity is 10¹² dPa·s is 730° C. or lower,
a relative dielectric constant (εᵣ) at a frequency of 10 GHz is 6.5 or less, and
a loss tangent (tan δ) at a frequency of 10 GHz is 0.0090 or less.

2. The glass plate according to claim 1, having an average thermal expansion coefficient at 50° C. to 350° C. of 40×10⁻⁷/K or more.

3. The glass plate according to claim 1, satisfying Al₂O₃-B₂O₃>0.0% in terms of molar percentage based on oxides.

4. The glass plate according to claim 1, being substantially free of B₂O₃.

5. The glass plate according to claim 1, satisfying 5.0%≤B₂03≤15% in terms of molar percentage based on oxides.

6. The glass plate according to claim 1, satisfying 0.0%≤B₂O₃≤5.0% in terms of molar percentage based on oxides.

7. The glass plate according to claim 1, having a visible light transmittance Tv defined by ISO-9050:2003 using a D65 light source of 75% or more when a thickness of the glass plate is converted into 2.00 mm.

8. The glass plate according to claim 1, having a total solar transmittance Tts defined by ISO-13837:2008 convention A and measured at a wind speed of 4 m/s of 88% or less when a thickness of the glass plate is converted into 2.00 mm.

9. The glass plate according to claim 1, wherein the temperature T₁₂ is 650° C. or lower.

10. The glass plate according to claim 1, wherein the relative dielectric constant (Fr) at the frequency of 10 GHz is 6.0 or less.

11. The glass plate according to claim 1, satisfying 3.0%≤Li₂0≤10% in terms of molar percentage based on oxides.

12. The glass plate according to claim 1, satisfying 1.8%≤MgO≤8.0% in terms of molar percentage based on oxides.

13. The glass plate according to claim 1, satisfying 71%≤SiO₂≤85% in terms of molar percentage based on oxides.

14. The glass plate according to claim 1, satisfying 0.05% Fe₂O₃≤1.00% in terms of molar percentage based on oxides.

15. A laminated glass comprising:
a first glass plate;
a second glass plate; and
an interlayer sandwiched between the first glass plate and the second glass plate, wherein
at least one of the first glass plate and the second glass plate is the glass plate according to claim 1.

16. The laminated glass according to claim 15, wherein the first glass plate, the second glass plate, and the interlayer have a total thickness of 6.00 mm or less, and
the laminated glass has a visible light transmittance Tv defined by ISO-9050:2003 using a D65 light source of 70% or more.

17. The laminated glass according to claim 15, wherein the first glass plate, the second glass plate, and the interlayer have a total thickness of 6.00 mm or less, and
the laminated glass has a total solar transmittance Tts defined by ISO-13837:2008 convention A and measured at a wind speed of 4 m/s of 80% or less.

18. The laminated glass according to claim 15, wherein the first glass plate, the second glass plate, and the interlayer have a total thickness of 6.00 mm or less, and
the laminated glass has a maximum value of a radio wave transmission loss S21 of −4.0 dB or more when a TM radio wave having a frequency of 75 GHz to 80 GHz is incident on the first glass plate at an incident angle of 60°.

19. The laminated glass according to claim 15, wherein the first glass plate, the second glass plate, and the interlayer have a total thickness of 6.00 mm or less, and
the laminated glass has a maximum value of a radio wave transmission loss S21 of −4.0 dB or more when a TM radio wave having a frequency of 75 GHz to 80 GHz is incident on the first glass plate at an incident angle of 45°.

20. The laminated glass according to claim 15, wherein the first glass plate, the second glass plate, and the interlayer have a total thickness of 6.00 mm or less, and
the laminated glass has a maximum value of a radio wave transmission loss S21 of −4.0 dB or more when a TM radio wave having a frequency of 75 GHz to 80 GHz is incident on the first glass plate at an incident angle of 20°.

21. A window glass for a vehicle, comprising the glass plate according to claim 1.

22. A window glass for a building, comprising the glass plate according to claim 1.

23. A window glass for a vehicle, comprising the laminated glass according to claim 15.
